(19) United States
(12) Patent Application Publication
(10) Pub. No.: US 2015/0143282 A1
(43) Pub. Date: May 21, 2015

(54) METHOD AND APPARATUS FOR DIAGONAL SCROLLING IN A USER INTERFACE

(71) Applicant: MOTOROLA SOLUTIONS, INC, SCHAUMBURG, IL (US)

(72) Inventors: TRUPTI TELANG, JERSEY CITY, NJ (US); ALEXANDER R SPIRO, ASTORIA, NY (US)

(73) Assignee: MOTOROLA SOLUTIONS, INC, SCHAUMBURG, IL (US)

(21) Appl. No.: 14/081,028

(22) Filed: Nov. 15, 2013

(51) Int. Cl. G06F 3/0485; G06F 3/0487; G06F 3/0482

(52) U.S. Cl. CPC G06F 3/0485; G06F 3/0482; G06F 3/0487
USPC 715/784

(57) ABSTRACT

A method and apparatus includes a user interface of a computing device for diagonal scrolling in a two-step selection process. The method includes presenting a main list and a sub-list substantially orthogonal to the main list, wherein the sub-list comprises elements associated with each element in the main list; receiving user input from a user to progress through the main list and/or the sub-list; and scrolling through the main list and/or the sub-list simultaneously responsive to the user input, wherein the main list and the sub-list are simultaneously scrolled responsive to a diagonal scrolling gesture as the user input.

### BACKGROUND OF THE INVENTION

The present disclosure relates to user interfaces. In computing devices, user interfaces provide input and output (I/O) for a user. Exemplary computing devices can include, without limitation, smart phones, tablets, subscriber units (SU), user equipment (UE), access terminals, laptops, net books, ultra books, desktop computers, and the like. An exemplary user interface includes a touch screen which serves a dual role in providing a display output as well as receiving input via a user's touch, a stylus, etc. In an exemplary operation on a user interface, often selection/setting requires choosing set of two values with elements in first step of selections leading to a list associated to that element for a second step of selections. This process can be referred to as a two-step selection process and requires navigation, which is frustrating in cases where user is not aware of which element to choose in the first step to reach a particular element in second step. Thus, the user has to navigate into each element and then navigate out to check for the next element. This process can be cumbersome and time-consuming. In mission critical applications, such as in the field of public safety, where time is of essence, having the user do such multiple steps to choose an option can be damaging and such a selection process increases cognitive load.

For example, denote a first list as (A, B, C, . . . ), and a second list as (1, 2, 3, . . . ). If the user is on the element 2 within list A and they wish to go to element 6 within list B, they will have to first navigate out of list A, then enter list B and then go to element 6. Also, several times the lists in both the steps are very long. Thus, the user has to first scroll one list and then scroll the second list making the process even more time consuming.

Accordingly, there is a need for a method and apparatus for diagonal scrolling in a user interface.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 are schematic diagrams of various stages of a user interface with diagonal scrolling in accordance with some embodiments.

FIG. 2 is a schematic diagram of the user interface of FIG. 1 illustrating exemplary scrolling direction gestures in accordance with some embodiments.

FIG. 3 is a schematic diagram of the user interface of FIG. 1 in a mobile device implementation in accordance with some embodiments.

FIGS. 4A-4B are schematic diagrams of various stages of a conventional user interface in a two-step selection process for a radio remote control application.

FIGS. 5A-5B are schematic diagrams of various stages of the user interface of FIG. 1 in the two-step selection process for a radio remote control application in accordance with some embodiments.

FIGS. 6A-6C are schematic diagrams of various stages of the conventional user interface in a two-step selection process using a form to select country and state.

FIGS. 7A-7B are schematic diagrams of various stages of the user interface of FIG. 1 in the two-step selection process using a form to select country and state in accordance with some embodiments.

FIGS. 8B-8C are schematic diagrams of various stages of the conventional user interface in a two-step selection process using a form to select month and year.

FIGS. 9A-9B are schematic diagrams of various stages of the user interface of FIG. 1 in the two-step selection process using a form to select month and year in accordance with some embodiments.

FIG. 10 is a flowchart of a method implemented on a user interface of FIG. 1 of a computing device in accordance with some embodiments.

FIG. 11 is a block diagram of a server which may be used for the user interface of FIG. 1 in accordance with some embodiments.

FIG. 12 is a block diagram of a mobile device which may be used for the user interface of FIG. 1 in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In an exemplary embodiment, a method implemented on a user interface of a computing device includes presenting a main list and a sub-list substantially orthogonal to the main list, wherein the sub-list comprises elements associated with each element in the main list; receiving user input from a user to progress through the main list and/or the sub-list; and scrolling through the main list and/or the sub-list simultaneously responsive to the user input, wherein the main list and the sub-list are simultaneously scrolled responsive to a diagonal scrolling gesture as the user input.

In another exemplary embodiment, a computing device utilizing diagonal scrolling includes a display; an input device; a processor communicatively coupled to the display and the input device; and memory storing instructions that, when executed, cause the processor to: present a main list and a sub-list substantially orthogonal to the main list on the display, wherein the sub-list comprises elements associated with each element in the main list; receive user input from the input device to progress through the main list and/or the sub-list; and cause the display to scroll through the main list and/or the sub-list simultaneously responsive to the user input, wherein the main list and the sub-list are simultaneously scrolled responsive to a diagonal scrolling gesture as the user input.

In yet another exemplary embodiment, software stored in a non-transitory computer readable medium and comprising instructions executable by a system, and in response to such execution causes the system to perform operations including presenting a main list and a sub-list substantially orthogonal to the main list, wherein the sub-list comprises elements associated with each element in the main list; receiving user input from a user to progress through the main list and/or the sub-list; and scrolling through the main list and/or the sub-list simultaneously responsive to the user input, wherein the main list and the sub-list are simultaneously scrolled responsive to a diagonal scrolling gesture as the user input.

In various exemplary embodiments, the method and apparatus includes diagonal scrolling in a user interface. Thus, a two-step selection process from a list and an associated sub list does not require navigation, i.e. a user does not have to navigate into and out of elements in the list to check the sub lists. Also, since the user can scroll both the list and the sub list at the same time, they spend less time to reach the desired element. This is especially important in cases of long lists. The method and apparatus includes placing two lists in the vertical and horizontal directions. For each element in the first list, the sub list is shown in the orthogonal direction thereto. The center of the screen is the focus area. Thus, the elements in first list and the second list in the focus area will be the selection. The user can scroll the first list. The user can scroll the corresponding sub list. They can also scroll diagonally, thus scrolling both lists at the same time.

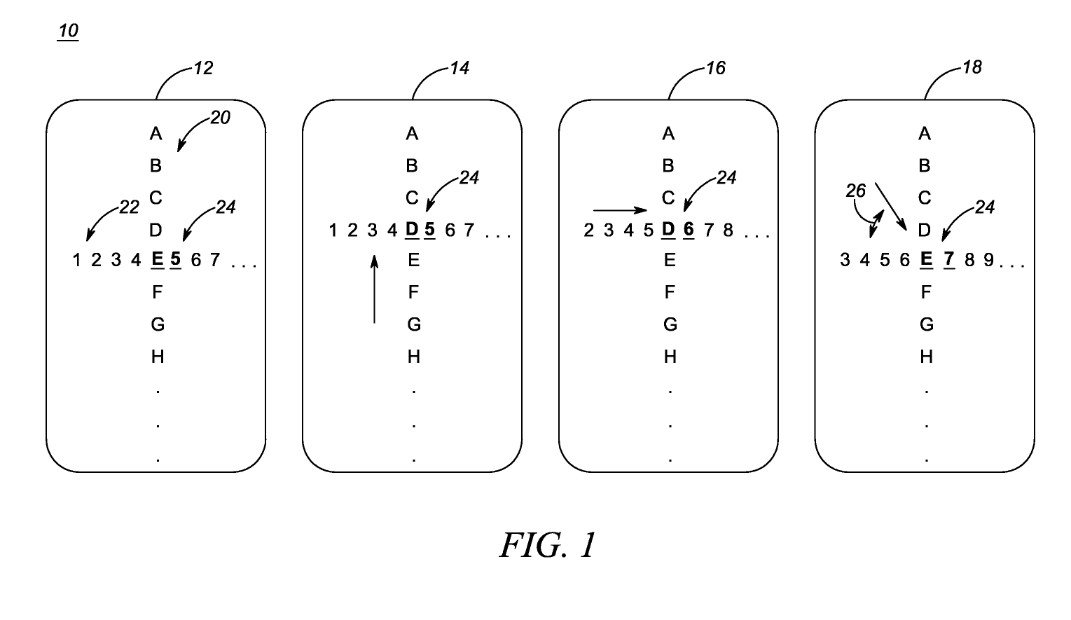

FIG. 1 illustrates various stages of a user interface 10 with diagonal scrolling in accordance with some embodiments. Specifically, the user interface 10 is shown in four stages 12, 14, 16, 18 to illustrate the diagonal scrolling. In an exemplary embodiment, the user interface 10 can include a touch screen that is capable of sensing a touch point and a scroll direction, collectively referred to as gesture control. Here, the user interface 10 simultaneously provides output via a display and input via the touch points and scroll directions sensed on the display. Other exemplary embodiments are also contemplated for input to the user interface 10 such as a mouse, a touchpad, a trackball, a stylus, a pen, or the like. Advantageously, the diagonal scrolling is especially convenient in mobile devices where the user interface 10 typically has limited space due to overall device size.

The four stages 12, 14, 16, 18 illustrate exemplary operations in the user interface 10. The user interface 10 includes a main list 20 shown in the vertical direction with elements {A, B, C, D, E, . . . } contained therein and a sub-list 22 associated with each element in the main list 20 in the horizontal direction. Of course, the main list 20 could be in the horizontal direction and the sub-list 22 in the vertical direction. That is, the sub-list 22 is substantially orthogonal to the main list 20, i.e. the sub-list 22 is perpendicular to the corresponding main list 20. The user interface 10 includes an element 24 in focus at a cross-over point between the main list 20 and the sub-list 22. The element 24 is chosen by a user associated with the user interface 10.

Operationally, the user interface 10 allows simultaneous scrolling of the main list 20 and the sub-list 22 without the aforementioned limitations of the two-step selection process. Specifically, a user can navigate the user interface 10 vertically to progress through the main list 20, horizontally to progress through the sub-list 22, or diagonally to progress through the main list 20 and the sub-list 22 simultaneously. Further, an angle of diagonal scrolling can control a speed in which the user progresses through the main list 20 and the sub-list 22 simultaneously. The user can utilize 360 degree scrolling to navigate the main list 20 and the sub-list 22 simultaneously.

In the exemplary operation of FIG. 1, at the stage 12, the user interface 10 has the element E5 as the element 24 in focus. At the stage 14, the user scrolls vertically up to bring the element D5 as the element 24 in focus. At the stage 16, the user scrolls horizontally to the right to bring the element D6 as the element 24 in focus. Finally, at the stage 18, the user scrolls diagonally down from the element D6 to bring the element E7 as the element 24 in focus. Further, an angle 26 at which the user diagonally scrolls can control a speed in which the user interface 10 progresses through the main list 20 and the sub-list 22 simultaneously. For example, a smaller angle relative to the sub-list 22 can include faster scrolling through the sub-list 22 relative to the main list, and vice versa for the main list 20.

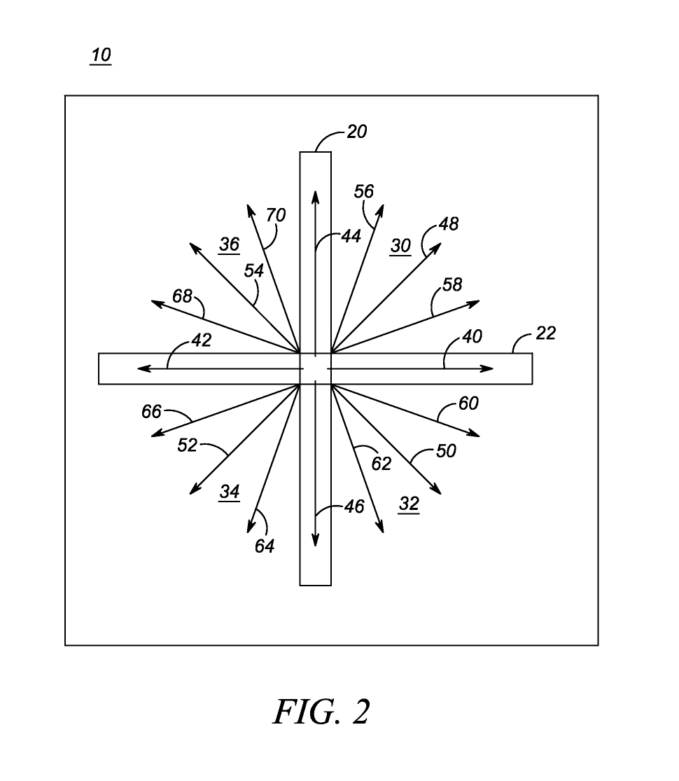

FIG. 2 is a schematic diagram of the user interface 10 illustrating exemplary scrolling directions in accordance with some embodiments. Again, the user interface 10 includes the main list 20 and the sub-list 22. The sub-list 22 is displayed for an associated element in focus in the main list 20. Again, the diagonal scrolling enables scrolling in any of 360 degrees through the main list 20 and/or the sub-list 22. FIG. 2 illustrates 16 exemplary scrolling directions. With the main list 20 and the sub-list 22 perpendicular to one another, the user interface 10 includes four quadrants 30, 32, 34, 36. The diagonal scrolling enables gestures in any of the four quadrants 30, 32, 34, 36 to simultaneously scroll the main list 20 and the sub-list 22 as well as gestures along the main list 20 or the sub-list 22 to solely scroll the main list 20 or the sub-list 22, i.e. gestures on the quadrant boundaries such as gestures 40, 42, 44, 46.

The gesture 40 scrolls the sub-list 22 to the right and the gesture 42 scrolls the sub-list 22 to the left, each without scrolling the main list 20. The gesture 44 scrolls the main list 20 upwards and the gesture 46 scrolls the main list 20 downwards, each without scrolling the sub-list 22. Diagonal gestures 48, 50, 52, 54 are about in a center of their respective quadrants 30, 32, 34, 36. The gesture 48 can scroll the main list 20 upwards and simultaneously scroll the sub-list 22 rightwards, each at the same speed of scrolling. The gesture 50 can scroll the main list 20 downwards and simultaneously scroll the sub-list 22 rightwards, each at the same speed of scrolling. The gesture 52 can scroll the main list 20 downwards and simultaneously scroll the sub-list 22 leftwards, each at the same speed of scrolling. The gesture 54 can scroll the main list 20 upwards and simultaneously scroll the sub-list 22 leftwards, each at the same speed of scrolling.

Of note, the diagonal gestures 48, 50, 52, 54 include an angle that is approximately relative to the main list 20 and the sub-list 22. When the angle is substantially greater for one of the main list 20 and the sub-list 22, the scrolling speed can be altered based thereon. For example, gestures 56, 58, 60, 62, 64, 66, 68, 70 illustrate exemplary angled scrolling with different speeds between the main list 20 and the sub-list 22. The gesture 56 can scroll the main list 20 upwards faster than the sub-list 22 scrolls rightwards. The gesture 58 can scroll the sub-list 22 rightwards faster than the main list 20 scrolls upwards. The gesture 60 can scroll the sub-list 22 rightwards faster than the main list 20 scrolls downwards. The gesture 62 can scroll the main list 20 downwards faster than the sub-list 22 scrolls rightwards. The gesture 64 can scroll the main list 20 downwards faster than the sub-list 22 scrolls leftwards. The gesture 66 can scroll the sub-list 22 leftwards faster than the main list 20 scrolls downwards. The gesture 68 can scroll the sub-list 22 leftwards faster than the main list 20 scrolls upwards. The gesture 70 can scroll the main list 20 upwards faster than the sub-list 22 scrolls leftwards.

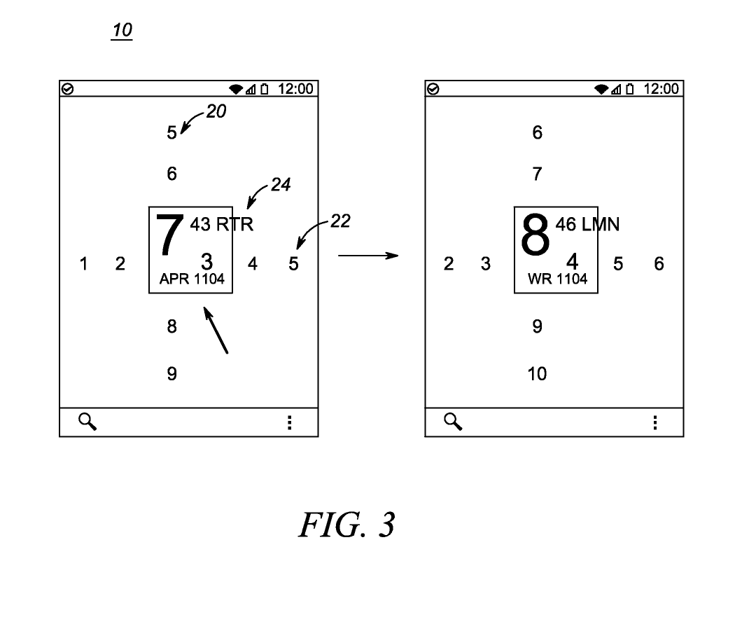

FIG. 3 illustrates the user interface 10 in a mobile device implementation in accordance with some embodiments. Specifically, FIG. 3 illustrates the user interface 10 with the main list 20 having an element 24 7 43 RTR in focus. In an exemplary use case, the user interface 10 can be used to select talk groups on a mobile device with the main list 20 being zones, for example, and the sub-list 22 being channels for each zone.

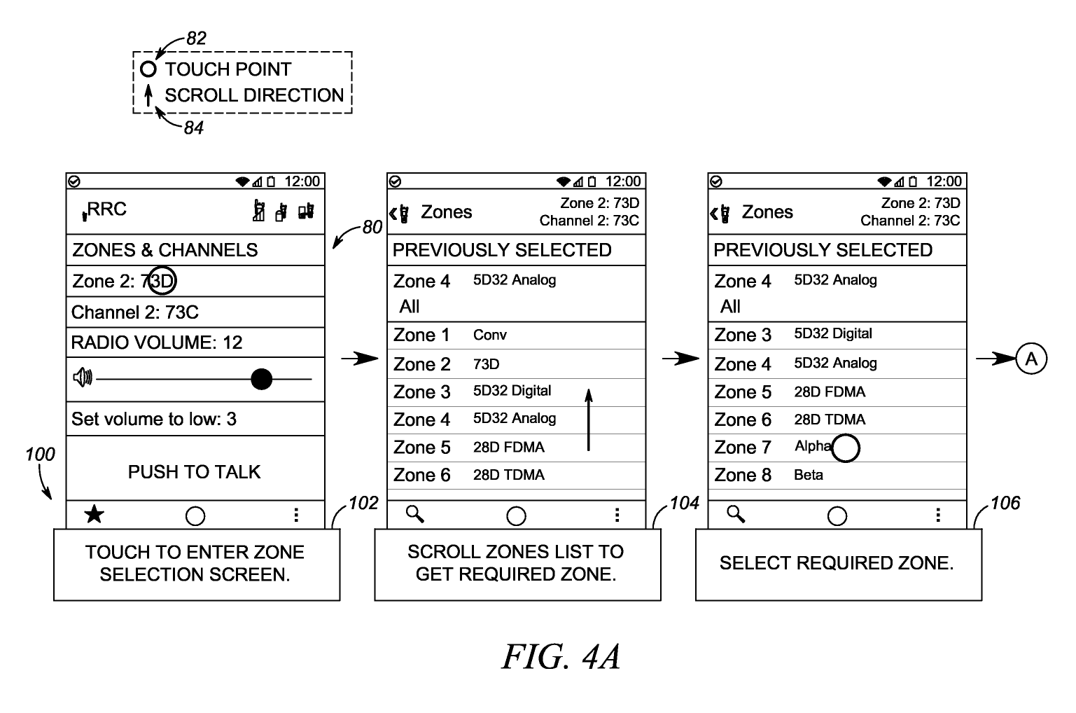

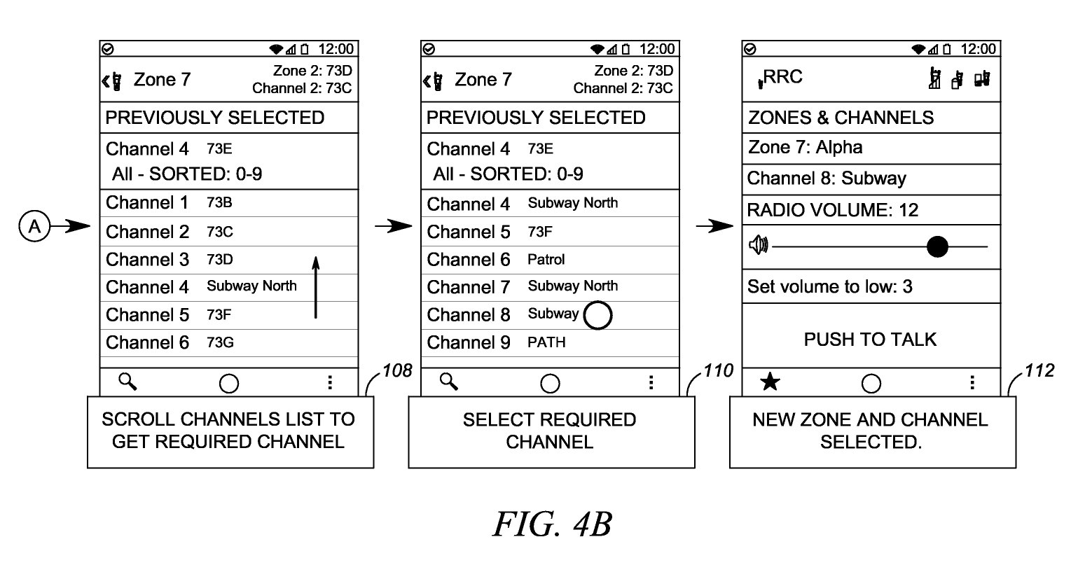

FIGS. 4A-4B illustrate various stages of a conventional user interface 80 in a two-step selection process for a radio remote control application. For illustration purposes, touch points are illustrated with circles 82 on the conventional user interface 80 and scrolling direction is illustrated by lines 84 with arrows. Specifically, FIGS. 4A-4B illustrate a process 100 for selecting channels on a mobile device using the conventional user interface 80. The process 100 includes touching the conventional user interface 80 to enter a zone selection screen (step 102). Next, the process 100 includes scrolling zones to get to a required zone (step 104) and the required zone is selected (step 106). Once the zone is selected, the process 100 includes scrolling through the channels to get to a required channel (step 108) and selecting the required channel (step 110). Finally, the process 100 includes a new zone and channel selected (step 112) on the radio remote control application. Of note, the process 100 using the conventional user interface 80 takes six steps in the two-step selection process.

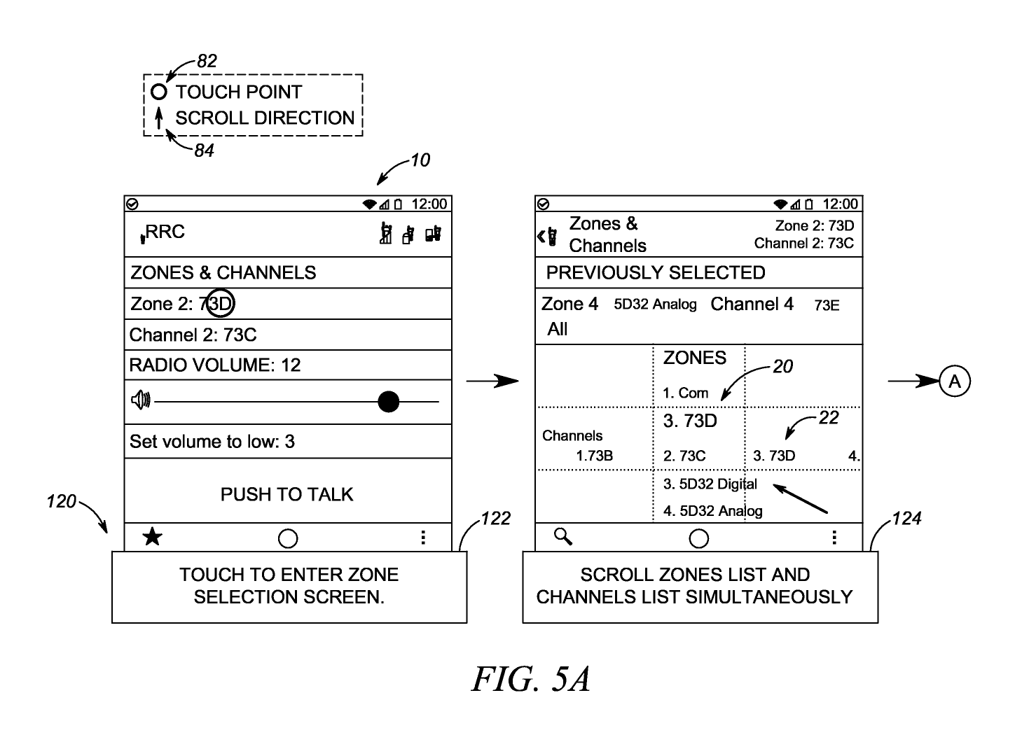

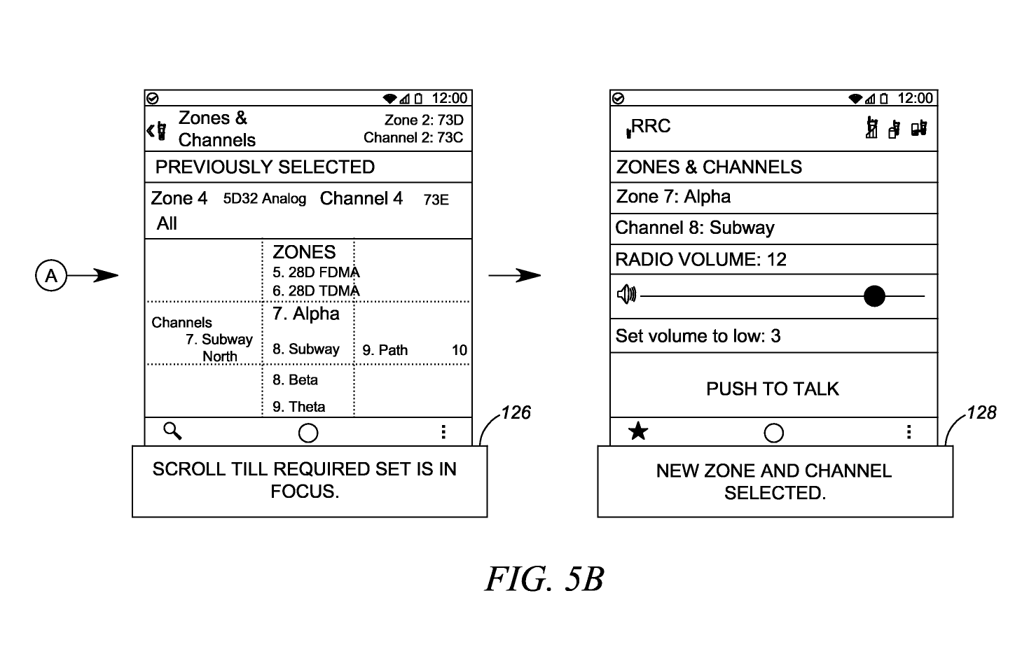

FIGS. 5A-5B illustrate various stages of the user interface 100 in the two-step selection process for a radio remote control application in accordance with some embodiments. Again, for illustration purposes, touch points are illustrated with circles 82 on the conventional user interface 80 and scrolling direction is illustrated by lines 84 with arrows. Specifically, FIGS. 5A-5B illustrate a process 120 for selecting channels on a mobile device using the user interface 10 with diagonal scrolling. The process 120 includes touching the user interface 10 to enter a zone selection screen (step 122). With the diagonal scrolling, the zones are including in the main list 20 and the channels are included in the sub-list 22. The process 120 include scrolling the zones list and channels list simultaneously (step 124) until the required set is in focus (step 126). Finally, the process 120 includes a new zone and channel selected (step 128) on the radio remote control application. As compared to the process 100, the process 120 is significantly streamlined and efficient. The process 120 can include tapping on the focus elements and releasing the finger and waiting for a pre-programmed duration for the focus elements to automatically get selected and auto return to the main screen.

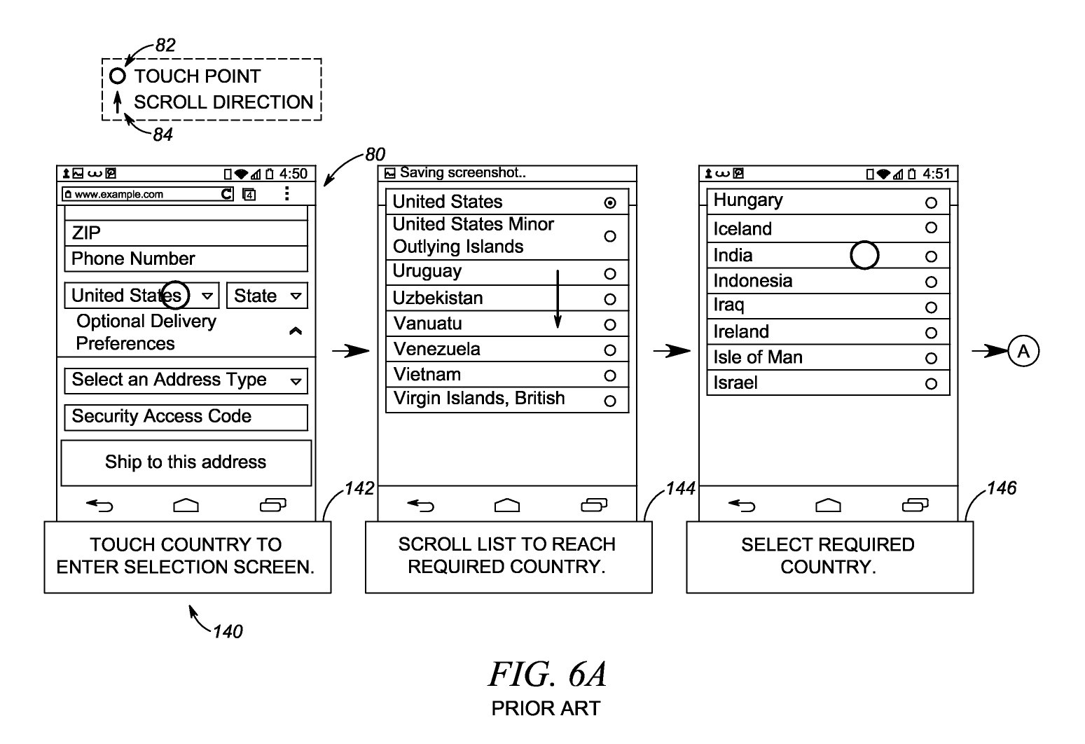

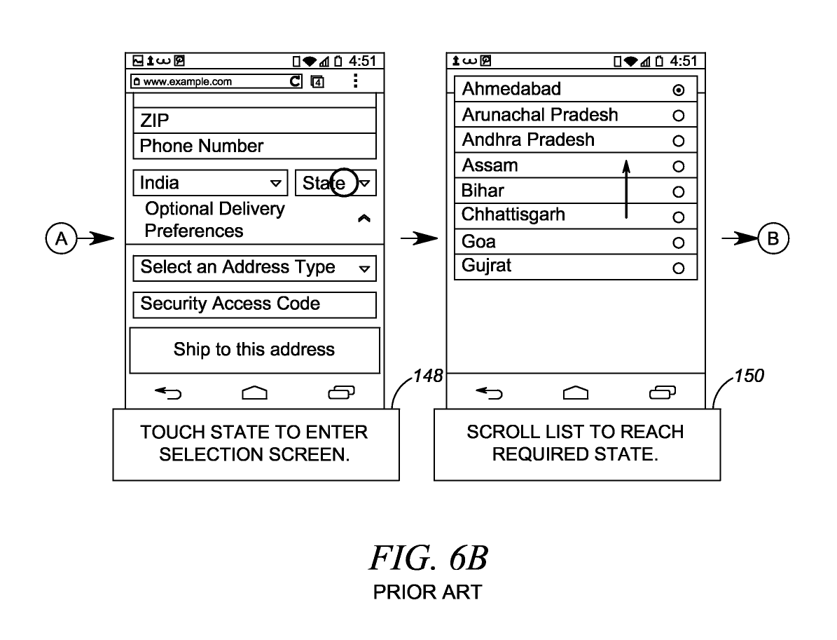

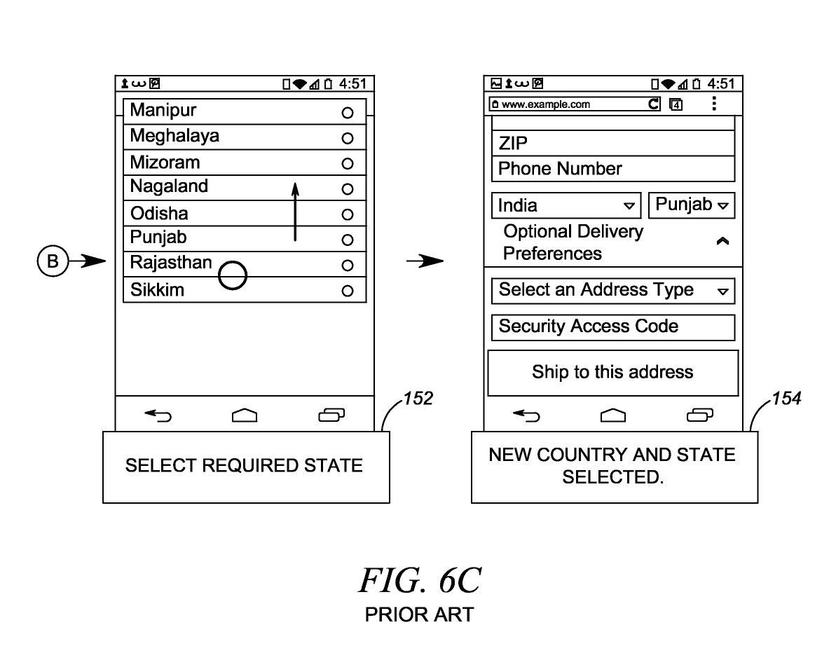

FIGS. 6A-6C illustrate various stages of the conventional user interface 80 in a two-step selection process using a form to select country and state. Again, for illustration purposes, touch points are illustrated with circles 82 on the conventional user interface 80 and scrolling direction is illustrated by lines 84 with arrows. Specifically, FIGS. 6A-6C illustrate a process 140 for selecting country and state (or province, region, etc.) in a form using the conventional user interface 80. The process 140 includes touching a country to enter a selection screen (step 142), scrolling a list to reach a required country (step 144), and selecting the required country (step 146). Next, the process 140 include touching a state to enter a state selection screen (step 148), scrolling a list to reach a required state (step 150), and selecting the required state (step 152). Finally, the process 140 includes a country and state selected (step 154) on the form.

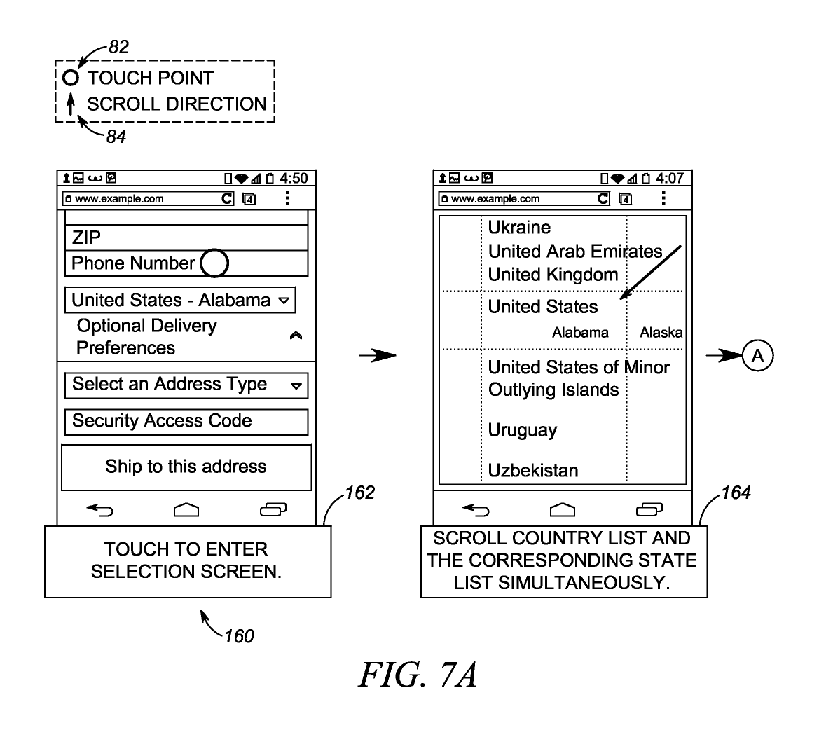

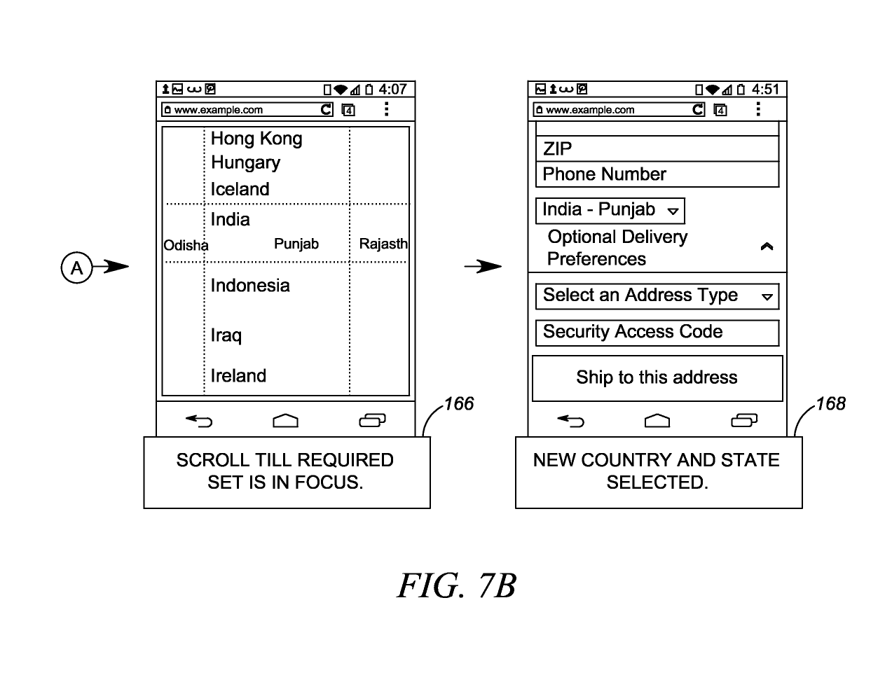

FIGS. 7A-7B illustrate various stages of the user interface 10 in the two-step selection process using a form to select country and state in accordance with some embodiments. Again, for illustration purposes, touch points are illustrated with circles 82 on the conventional user interface 80 and scrolling direction is illustrated by lines 84 with arrows. Specifically, FIGS. 7A-7B illustrate a process 160 for selecting country and state (or province, region, etc.) in a form using the user interface 10 with diagonal scrolling. The process 160 includes touching the user interface 10 to enter a selection screen (step 162), scrolling a country list and a corresponding state list simultaneously (step 164) until the required set is in focus (step 166). Finally, the process 140 includes a country and state selected (step 168) on the form. As compared to the process 140, the process 160 is significantly streamlined and efficient. The process 160 can include tapping on the focus elements and releasing the finger and waiting for a pre-programmed duration for the focus elements to automatically get selected and auto return to the main screen.

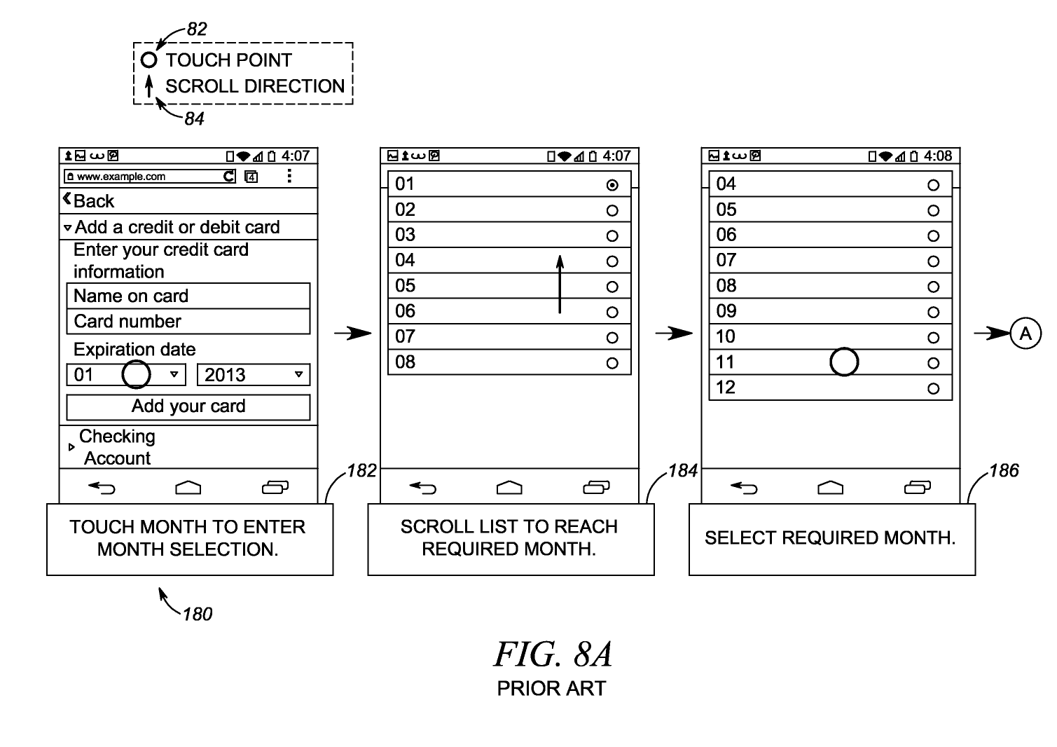

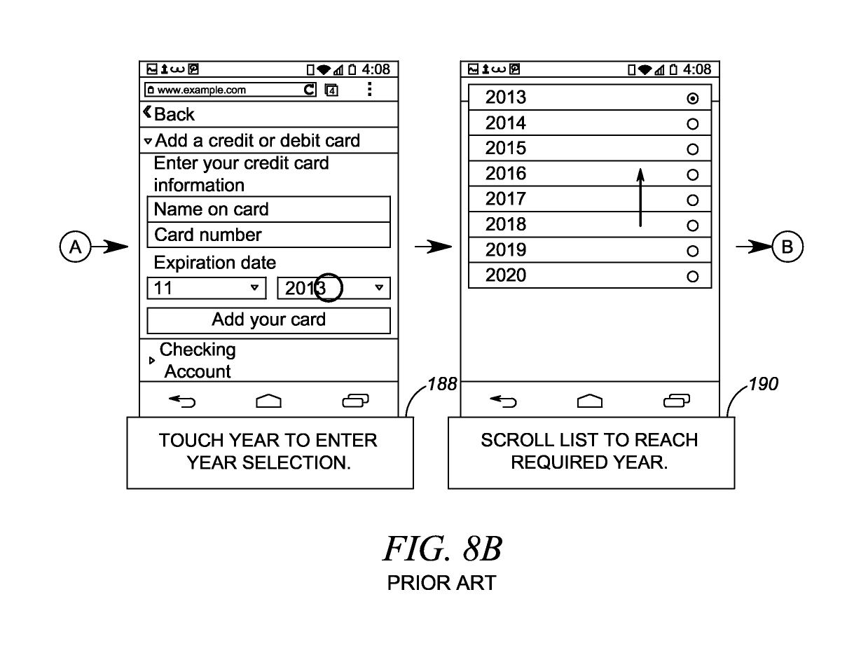

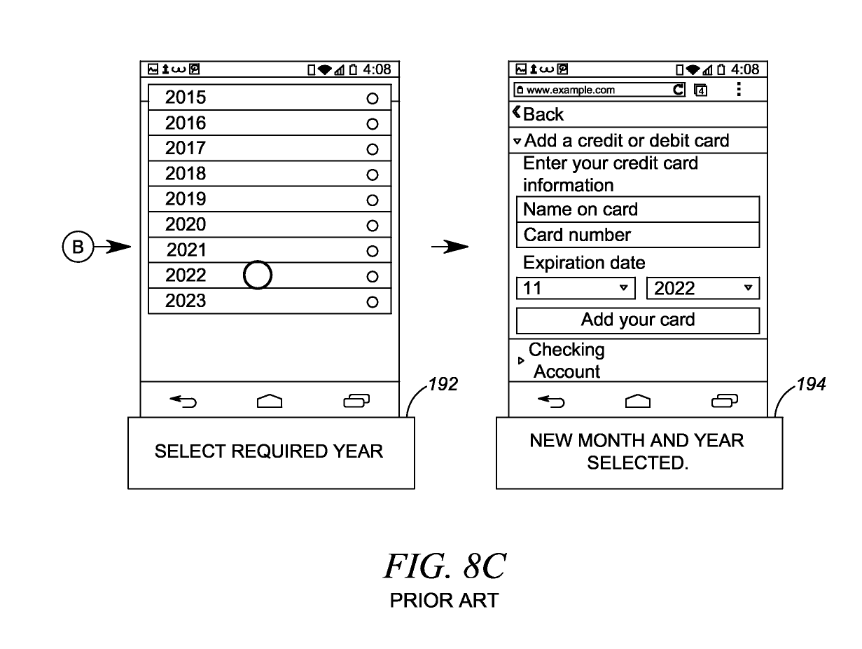

FIGS. 8B-8C illustrate various stages of the conventional user interface 80 in a two-step selection process using a form to select month and year. Again, for illustration purposes, touch points are illustrated with circles 82 on the conventional user interface 80 and scrolling direction is illustrated by lines 84 with arrows. Specifically, FIGS. 8B-8C illustrate a process 180 for selecting month and year in a form using the conventional user interface 80. The process 180 includes touching a month to enter month selection on the conventional user interface 80 (step 182), scrolling a list to reach a required month (step 184), and selecting the required month (step 186). Next, the process 180 includes touching a year to enter a year selection (step 188), scrolling a list to reach a required year (step 190), and selecting the required year (step 192). Finally, the process 180 includes a month and year selected (step 194) on the form.

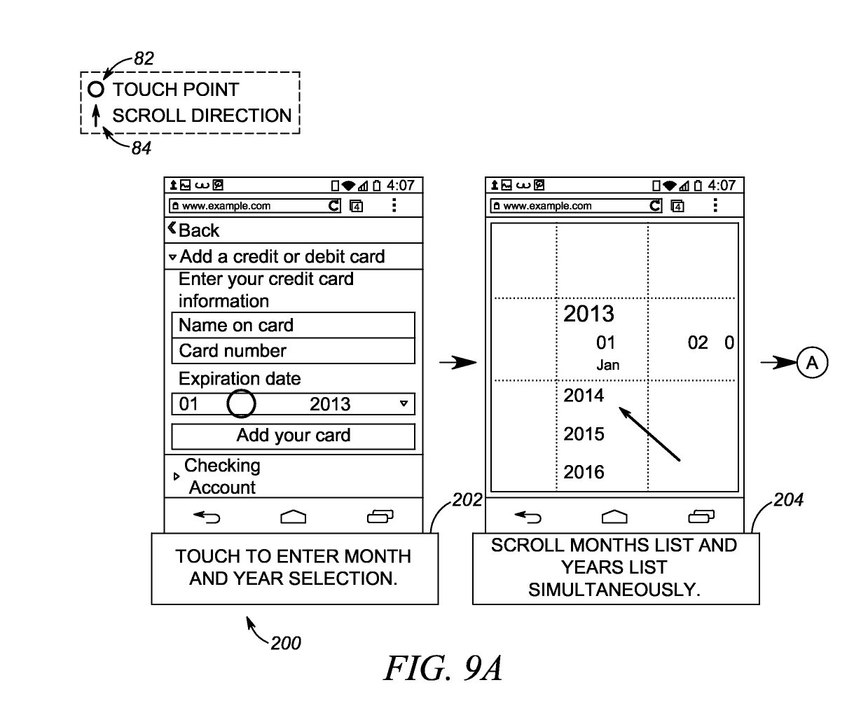

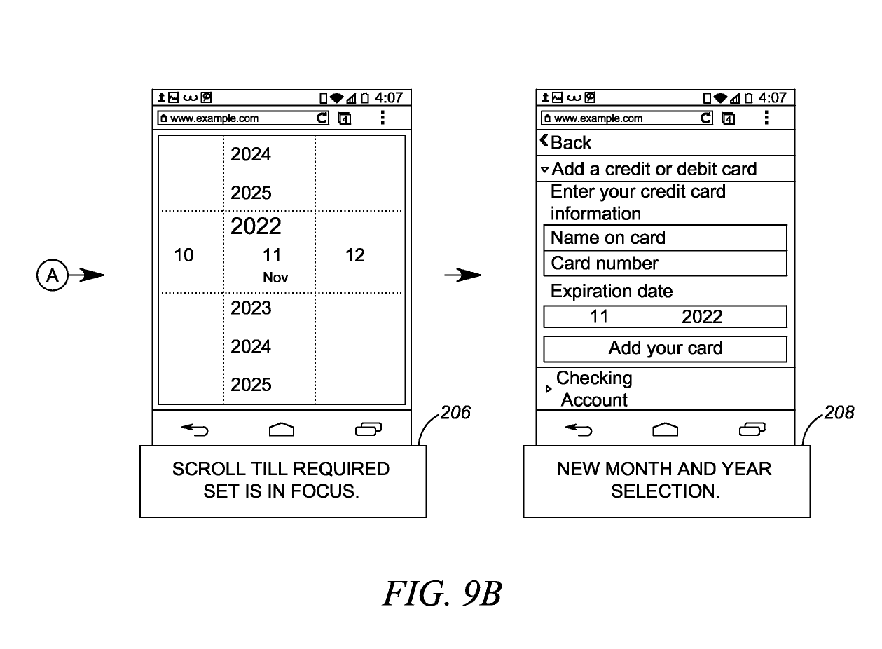

FIGS. 9A-9B illustrate various stages of the user interface 10 in the two-step selection process using a form to select month and year in accordance with some embodiments. Again, for illustration purposes, touch points are illustrated with circles 82 on the conventional user interface 80 and scrolling direction is illustrated by lines 84 with arrows. Specifically, FIGS. 9A-9B illustrates a process 200 for selecting month and year in a form using the user interface 10 with diagonal scrolling. The process 200 includes touching a month and year to enter a selection (step 202), scrolling a month list and a year list simultaneously (step 204) until the required set is in focus (step 206). Finally, the process 200 includes a month and state year (step 208) on the form. As compared to the process 180, the process 200 is significantly streamlined and efficient. The process 200 can include tapping on the focus elements and releasing the finger and waiting for a pre-programmed duration for the focus elements to automatically get selected and auto return to the main screen.

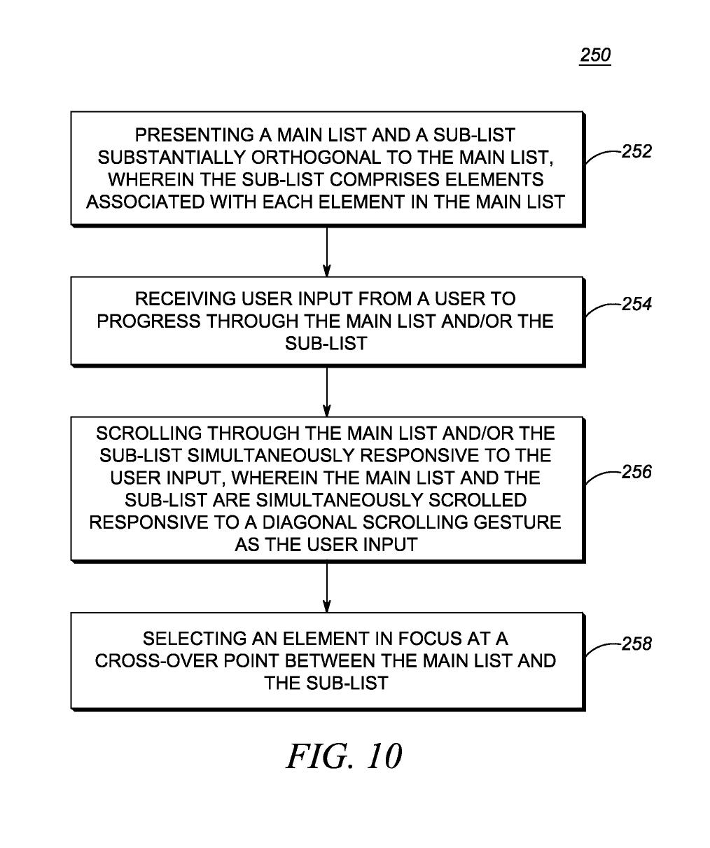

FIG. 10 is a flowchart of a method 250 implemented on a user interface of a computing device in accordance with some embodiments. Specifically, the method 250 can be implemented on the user interface 10. The method 250 includes presenting a main list and a sub-list substantially orthogonal to the main list, wherein the sub-list comprises elements associated with each element in the main list (step 252). The method 250 further includes receiving user input from a user to progress through the main list and/or the sub-list (step 254). The method 250 further includes scrolling through the main list and/or the sub-list simultaneously responsive to the user input, wherein the main list and the sub-list are simultaneously scrolled responsive to a diagonal scrolling gesture as the user input.

The method 250 can further include selecting an element in focus at a cross-over point between the main list and the sub-list. Optionally, the main list is displayed vertically and the sub-list is displayed horizontally, and the method 250 can further include displaying the sub-list associated with an element in the main list in focus at a cross-over point between the main list and the sub-list. The method 250 can further include receiving the user input comprising one of a horizontal gesture or a vertical gesture; and scrolling one of the main list or the sub-list responsive to the horizontal gesture or the vertical gesture. The method 250 can further include receiving the user input comprising a diagonal gesture; and scrolling both the main list and the sub-list simultaneously to the diagonal gesture.

The method 250 can further include receiving the user input comprising a diagonal gesture; and scrolling both the main list and the sub-list simultaneously to the diagonal gesture, wherein a speed of the scrolling the main list and the sub-list is based on an angle of the diagonal gesture. If the angle is smaller to the main list than the sub-list, then the scrolling is faster on the main list than the sub-list, and if the angle is smaller to the sub-list than the main list, then the scrolling is faster on the sub-list than the main list. Optionally, the computing device comprises a mobile device, the main list comprises zones, and the sub-list comprises channels. Alternatively, the main list comprises countries, and the sub-list comprises states. Additionally, the main list comprises months, and the sub-list comprises years.

In the various aforementioned exemplary embodiments, the main list and the sub-list are illustrated orthogonal to one another. However, the systems and methods contemplate other arrangements such as where the main list and the sub-list are at an angle to one another, i.e. not orthogonal, or where the main list and the sub-list are parallel to one another. In these cases, the scrolling between the lists may be different directions or multi-directional. Other exemplary embodiments are also contemplated such as where a two finger scroll or the like is utilized to scroll both lists simultaneously (other gestures are also contemplated such as a circular swipe or the like).

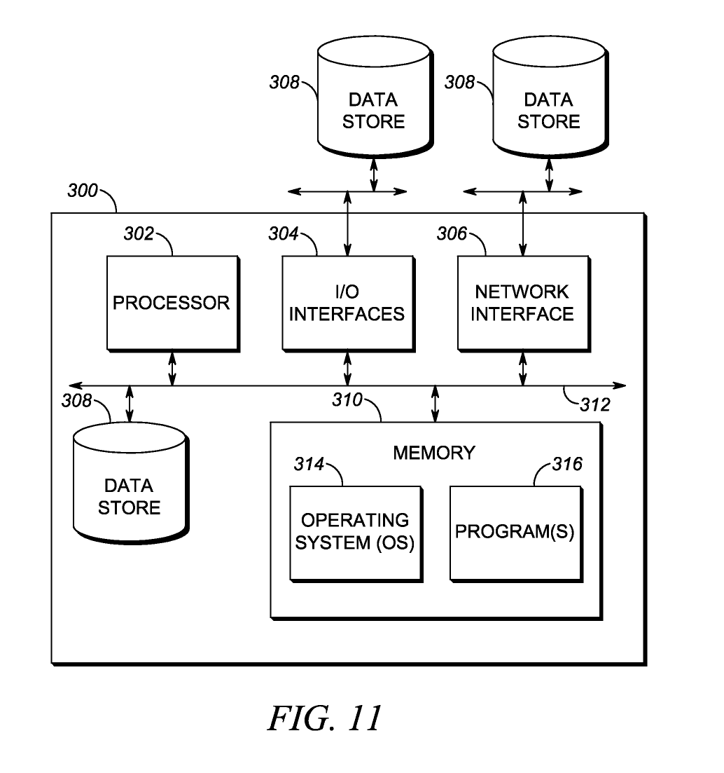

FIG. 11 is a block diagram of a server 300 which may be used for the user interface 10 in accordance with some embodiments. Specifically, the server 300 can be configured to implement the method 250. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 11 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, touch screen, a stylus, a pen, and/or a mouse. The user input is configured to receive commands or gestures from a user for the diagonal scrolling. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, a wide area network (WAN), a local area network (LAN), and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 includes a suitable operating system (0/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

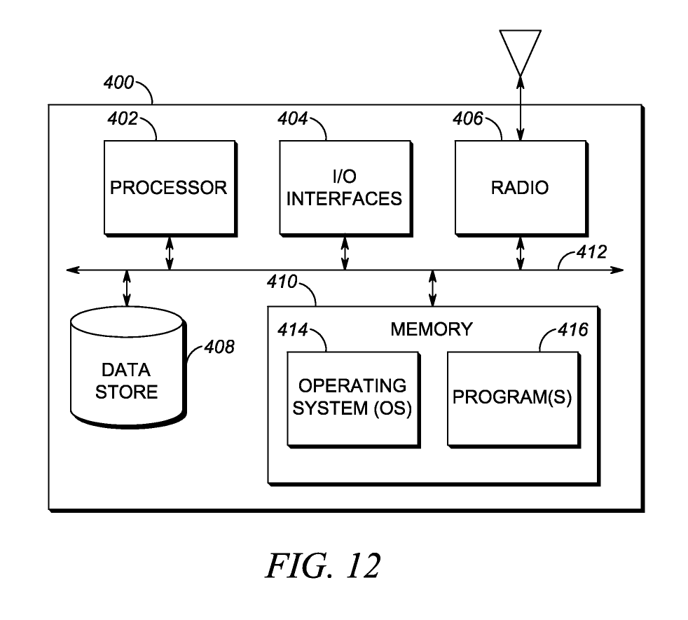

FIG. 12 is a block diagram of a mobile device 400 which may be used for the user interface 10 in accordance with some embodiments. Specifically, mobile device 400 can be configured to implement the method 250. The mobile device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 12 depicts the mobile device 400 in an oversimplified manner, and a practical embodiment may include additional components and suitably configured processing logic to support known or conventional operating features that are not described in detail herein. The components (402, 404, 406, 408, and 402) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the mobile device 400, a semiconductor-based microprocessor (in the form of a microchip or chip set), or generally any device for executing software instructions. When the mobile device 400 is in operation, the processor 402 is configured to execute software stored within the memory 410, to communicate data to and from the memory 410, and to generally control operations of the mobile device 400 pursuant to the software instructions. In an exemplary embodiment, the processor 402 may include a mobile optimized processor such as optimized for power consumption and mobile applications. The I/O interfaces 404 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the mobile device 400. Additionally, the I/O interfaces 404 may further include an imaging device, i.e. camera, video camera, etc.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions.

In the example of FIG. 12, the software in the memory 410 includes a suitable operating system (O/S) 414 and programs 416. The operating system 414 essentially controls the execution of other computer programs, and provides scheduling, input-output control, file and data management, memory management, and communication control and related services. The programs 416 may include various applications, add-ons, etc. configured to provide end user functionality with the mobile device 400. For example, exemplary programs 416 may include, but not limited to, a web browser, social networking applications, streaming media applications, games, mapping and location applications, electronic mail applications, financial applications, and the like. As described herein, the user interface 10 is advantageous with respect to the mobile device 400 due to limitations in display size. In an exemplary embodiment, the user interface 10 can be used to select zones and channels for operation of the radio 406 as well as other applications.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method implemented on a user interface of a computing device, the method comprising:
presenting a main list and a sub-list substantially orthogonal to the main list, wherein the sub-list comprises elements associated with each element in the main list;
receiving user input from a user to progress through the main list and/or the sub-list; and
scrolling through the main list and/or the sub-list simultaneously responsive to the user input, wherein the main list and the sub-list are simultaneously scrolled responsive to a diagonal scrolling gesture as the user input.

2. The method of claim 1, further comprising:
selecting an element in focus at a cross-over point between the main list and the sub-list.

3. The method of claim 1, wherein the main list is displayed vertically and the sub-list is displayed horizontally, and the method further comprising:
displaying the sub-list associated with an element in the main list in focus at a cross-over point between the main list and the sub-list.

4. The method of claim 1, further comprising:
receiving the user input comprising one of a horizontal gesture or a vertical gesture; and
scrolling one of the main list or the sub-list responsive to the horizontal gesture or the vertical gesture.

5. The method of claim 4, further comprising:
receiving the user input comprising a diagonal gesture; and
scrolling both the main list and the sub-list simultaneously to the diagonal gesture.

6. The method of claim 1, further comprising:
receiving the user input comprising a diagonal gesture; and
scrolling both the main list and the sub-list simultaneously to the diagonal gesture, wherein a speed of the scrolling the main list and the sub-list is based on an angle of the diagonal gesture.

7. The method of claim 6, wherein if the angle is smaller to the main list than the sub-list, then the scrolling is faster on the main list than the sub-list, and if the angle is smaller to the sub-list than the main list, then the scrolling is faster on the sub-list than the main list.

8. The method of claim 1, wherein the computing device comprises a mobile device, the main list comprises zones, and the sub-list comprises channels.

9. The method of claim 1, wherein the main list comprises countries, and the sub-list comprises states.

10. The method of claim 1, wherein the main list comprises months, and the sub-list comprises years.

11. A computing device utilizing diagonal scrolling, the computing device comprising:
a display;
an input device;
a processor communicatively coupled to the display and the input device; and
memory storing instructions that, when executed, cause the processor to:
present a main list and a sub-list substantially orthogonal to the main list on the display, wherein the sub-list comprises elements associated with each element in the main list;
receive user input from the input device to progress through the main list and/or the sub-list; and
cause the display to scroll through the main list and/or the sub-list simultaneously responsive to the user input, wherein the main list and the sub-list are simultaneously scrolled responsive to a diagonal scrolling gesture as the user input.

12. The computing device of claim 11, wherein the instructions that, when executed, further cause the processor to:
select an element in focus at a cross-over point between the main list and the sub-list.

13. The computing device of claim 11, wherein the main list is displayed vertically and the sub-list is displayed horizontally, and wherein the instructions that, when executed, further cause the processor to:
display the sub-list associated with an element in the main list in focus at a cross-over point between the main list and the sub-list.

14. The computing device of claim 11, wherein the instructions that, when executed, further cause the processor to:
receive the user input comprising one of a horizontal gesture or a vertical gesture; and
scroll one of the main list or the sub-list responsive to the horizontal gesture or the vertical gesture.

15. The computing device of claim 14, wherein the instructions that, when executed, further cause the processor to:
receive the user input comprising a diagonal gesture; and
scroll both the main list and the sub-list simultaneously to the diagonal gesture.

16. The computing device of claim 11, wherein the instructions that, when executed, further cause the processor to:
receive the user input comprising a diagonal gesture; and
scroll both the main list and the sub-list simultaneously to the diagonal gesture, wherein a speed of the scrolling the main list and the sub-list is based on an angle of the diagonal gesture.

17. The computing device of claim 16, wherein if the angle is smaller to the main list than the sub-list, then the scrolling is faster on the main list than the sub-list, and if the angle is smaller to the sub-list than the main list, then the scrolling is faster on the sub-list than the main list.

18. The computing device of claim 11, further comprising:
a radio;
wherein the computing device comprises a mobile device, the main list comprises zones, and the sub-list comprises channels for operation of the radio.

19. Software stored in a non-transitory computer readable medium and comprising instructions executable by a system, and in response to such execution causes the system to perform operations comprising:
presenting a main list and a sub-list substantially orthogonal to the main list, wherein the sub-list comprises elements associated with each element in the main list;
receiving user input from a user to progress through the main list and/or the sub-list; and
scrolling through the main list and/or the sub-list simultaneously responsive to the user input, wherein the main list and the sub-list are simultaneously scrolled responsive to a diagonal scrolling gesture as the user input.
